(19) United States
(12) Patent Application Publication
(10) Pub. No.: US 2012/0314456 A1
(43) Pub. Date: Dec. 13, 2012

(54) SYNCHRONOUS AC RECTIFIED FLYBACK CONVERTER UTILIZING BOOST INDUCTOR

(75) Inventor: THOMAS W. LANNI, Laguna Niguel, CA (US)

(73) Assignee: COMARCO WIRELESS TECHNOLOGIES, INC., Lake Forest, CA (US)

(21) Appl. No.: 13/156,593

(22) Filed: Jun. 9, 2011

(51) Int. Cl. H02M 3/335

(52) U.S. Cl. 363/21.02

(57) ABSTRACT

A flyback converter utilizes a boost inductor coupled between a source of AC power and a synchronous rectifier to provide power factor correction. The synchronous rectifier includes four field-effect transistors configured in a bridge arrangement. Control circuitry controls the on/off states of opposite pairs of the FETs to provide synchronous rectification of the AC power. A primary winding of the flyback transformer is coupled in series with a storage capacitor across the output of the synchronous rectifier. A circuit, which includes a switching transistor, is also coupled across the output of the synchronous rectifier to provide a low resistance path when the switch is closed. The cores of the boost inductor and the transformer are loaded with energy when the switch is closed. When the switch opens, the energy stored in the magnetic cores is transferred to the output via the transformer secondary winding and rectification circuitry. In one embodiment, a separate switching transistor is not used and its function is performed by the rectifier FETs.

### RELATED APPLICATION

This application is in the same technical field as U.S. patent application Ser. No. 12/646,152, filed Dec. 23, 2009, the disclosure of which is incorporated herein by reference.

### FIELD OF THE INVENTION

The present invention relates to power supplies, also known as power adapters and power converters. In particular, the invention concerns a flyback converter which utilizes a boost inductor coupled between a source of AC power and a synchronous rectifier to provide power factor correction and low conduction loss associated with rectification.

### BACKGROUND OF THE INVENTION

Power factor is the ratio of real power to apparent power. Real power is the average (over a cycle) of the instantaneous product of current and voltage. Apparent power is the product of the RMS value of current times the RMS value of voltage. Real power is the power required to do the needed work. Apparent power is the power that is supplied by the electricity generator (e.g., a power company). If the current and voltage are both sinusoidal and in phase, the power factor is 1. If the current and voltage are both sinusoidal, but not in phase, the power factor is equal to the cosine of the phase angle (“θ”) between the current and voltage waveforms. In cases where the load (as seen by the supply line) is composed of resistive, capacitive and inductive elements which behave linearly, both the current and voltage are sinusoidal and the power factor=cosine θ definition of power factor is applicable. If the load appears purely resistive, the current and voltage are in phase (due to no reactive impedance), in which case apparent power equals real power, i.e., the power factor is 1 (the cosine of 0°=1).

Most power supplies, however, present a non-linear, rather than a linear, load impedance to the AC mains. This is because the power supply input circuit typically consists of a half-wave or full-wave rectifier followed by a storage capacitor. The capacitor is charged to maintain a voltage approximately equal to the peak of the input sine wave until the next peak arrives to recharge the capacitor. As a result, current is drawn from the input only during the relative short period of time when the input voltage waveform is near its peak. For a 240 VAC at 50 Hz supply voltage, FIG. 6A depicts the input current of a typical switched-mode power supply without any power factor correction (PFC).

Although the sinusoidal input voltage waveform is not shown in FIG. 6A, the input current waveform is in phase with such input voltage waveform. Utilizing only the “cosine θ” definition of power factor would lead to the conclusion that the power supply has a power factor of 1, which is not the case.

When the input voltage is sinusoidal, but the input current is not (as in FIG. 6A), power factor consists of two components: i) the displacement factor related to the phase angle; and ii) a distortion factor related to wave shape. Expressed as a function of the total harmonic distortion (THD %) of the current waveform, the distortion factor, Kd, is calculated by the following equation:

$$Kd = \frac{1}{\sqrt{1 + {( \frac{THD ( \% )}{100} )}^{2}}} \qquad ( 1 )$$

If the fundamental component of the input current is in phase with the input voltage, the power factor is determined only by the distortion factor Kd, set forth above. As an example for such a case, a 10% THD of the current waveform corresponds to a power factor PF of approximately 0.995.

High harmonic content in the current waveform not only lowers the power factor, the harmonics may travel down the neutral line of the AC mains and disrupt other devices connected thereto. The European Union has adopted regulations (EN61000-3-2) which establish limits on the harmonics of the AC input current up to the 40^{th} harmonic. The regulations are more vigorous with respect to personal computers, PC monitors and television receivers than with respect to other devices.

To lower the harmonic content of the current waveform and improve power factor, so-called power factor correction circuits are utilized. Power factor correction is potentially attainable utilizing passive circuitry. However, due to component size constraints, power factor correction circuits which use active circuits are more common.

Conventionally, the active power factor correction circuitry is placed between the input rectifier and the storage capacitor. In single-stage power factor corrected converters, a power factor correction stage is combined with DC/DC conversion circuitry. Examples of such circuits are discussed in i) Qian, Jinrong, “Advanced Single-Stage Power Factor Correction Techniques,” Virginia Polytechnic Institute and State University Ph.D. Dissertation, Sep. 25, 1997, pp. i-xi, 1-175 (see section 2.4 thereof and FIG. 2.11 in particular); ii) U.S. Pat. No. 6,108,218 (see FIGS. 1-5 thereof); iii) U.S. Pat. No. 6,473,318 (see FIG. 9 thereof); and iv) U.S. Pat. No. 6,751,104 (see FIGS. 5 and 12 thereof).

These prior art circuits include a bridge rectifier, a transformer, a switch and storage capacitor in various configurations. These circuits employ an auxiliary transformer winding in the current path as, or in addition to, a boost inductor which is located on the output side of the bridge rectifier. Such configurations require use of at least one diode in addition to those utilized in the bridge rectifier to prevent back voltage stress on the bridge rectifier. Such an arrangement increases component count and associated cost.

Use of a diode bridge rectifier causes conduction loss. In a four diode bridge rectifier, two of the four diodes are always forward biased, i.e., conducting current. This results in continuous conduction losses which decrease the efficiency of the power converter. The conduction losses also cause the undesirable generation of heat.

### SUMMARY OF THE INVENTION

The present invention is a flyback converter which utilizes transistors to perform synchronous rectification, i.e., rectification synchronous with the line frequency of the AC power. A boost inductor is coupled between the source of AC power and an input to the synchronous rectifier to provide power factor correction. A primary winding of the flyback transformer is coupled in series with a storage capacitor across the output of the synchronous rectifier. A circuit which includes a switch, illustratively a switching transistor, is also coupled across the output of the synchronous rectifier to provide a low resistance path when the switch is closed.

When the switch is closed, energy from the AC power source is stored in the magnetic core of the boost inductor and simultaneously energy from the storage capacitor is stored in the magnetic core of the flyback transformer. When the switch opens, the energy stored in the boost inductor magnetic core is released as current which flows through the primary winding to the storage capacitor, and simultaneously the energy stored in the magnetic core of the flyback transformer is released. The flow of current through the transformer primary and the release of the energy stored in the transformer magnetic core result in current flow in the secondary winding of the transformer, which current is rectified to generate a DC output voltage.

A control circuit controls the on/off state of the switching transistor. When the switching transistor is on, the control circuit compares the current flowing through the transistor to a feedback signal proportional to the DC output voltage. Based on the comparison, the control circuit determines when sufficient energy has been delivered to the magnetic cores of the boost inductor and the transformer to maintain the desired output voltage. When the condition is met, the control circuit causes the switching transistor to turn off. By monitoring an auxiliary transformer winding, the control circuit cases the transistor to remain off until all of the energy stored in the magnetic cores of the boost inductor and transformer has been delivered to the seconding winding. The switching frequency of the switching transistor may be in the range of 50-120 KHZ.

Additional control circuits control the on/off state of the transistors used to perform the synchronous rectification of the AC input current. The AC line frequency is typically in the range of 50-60 Hz. Four field effect transistors (FETs) are configured in a bridge arrangement and controlled such that one pair of transistors is conducting and the other pair is not conducting depending on the phase (positive or negative) of the sinusoidal AC input voltage. The pair of transistors which are on allow current to flow from a first terminal of the AC power source, through the boost inductor, through one of the on transistors, to the primary winding and the capacitor (assuming that the switching transistor is off), through the other on transistor and return to the other terminal of the AC power source. Current is blocked from flowing through the other pair of transistors due to the inherent body diode (parasitic diode) characteristic of a field effect transistor which is in the off state.

In one embodiment, the primary of the flyback transformer includes two primary windings with the storage capacitor coupled therebetween. Likewise, the boost inductor includes two windings wound around a common magnetic core. Each of the boost inductor windings is coupled between a converter input terminal and an input to the synchronous rectifier. An EMI filter may be disposed between the converter input terminals and the boost inductor.

In another embodiment, the switching transistor is not used and its function is performed by the transistors used as the synchronous rectifier. That is, in addition to performing their synchronous rectification function at the AC line frequency, the four transistors are switched at the switching frequency. All four of the transistors are turned on to cause energy to be stored in the boost core and to cause energy from the storage capacitor to be stored in the magnetic core of the flyback transformer.

### BRIEF DESCRIPTION OF THE DRAWINGS

FIG. 1 is a combination block diagram/schematic diagram of a circuit according to a first embodiment of the invention;

FIG. 2 is a portion of a schematic diagram according to the first embodiment of the invention;

FIG. 3 is another portion of the schematic diagram according to the first embodiment of the invention;

FIG. 4 is a combination block diagram/schematic diagram according to a second embodiment of the invention;

FIG. 5 is a portion of a schematic diagram according to the second embodiment of the invention;

FIG. 6A illustrates a current waveform for a prior art power supply without power factor correction; and

FIG. 6B illustrates a current waveform for the power supply according to an embodiment of the invention.

### DETAILED DESCRIPTION OF THE PREFERRED EMBODIMENT

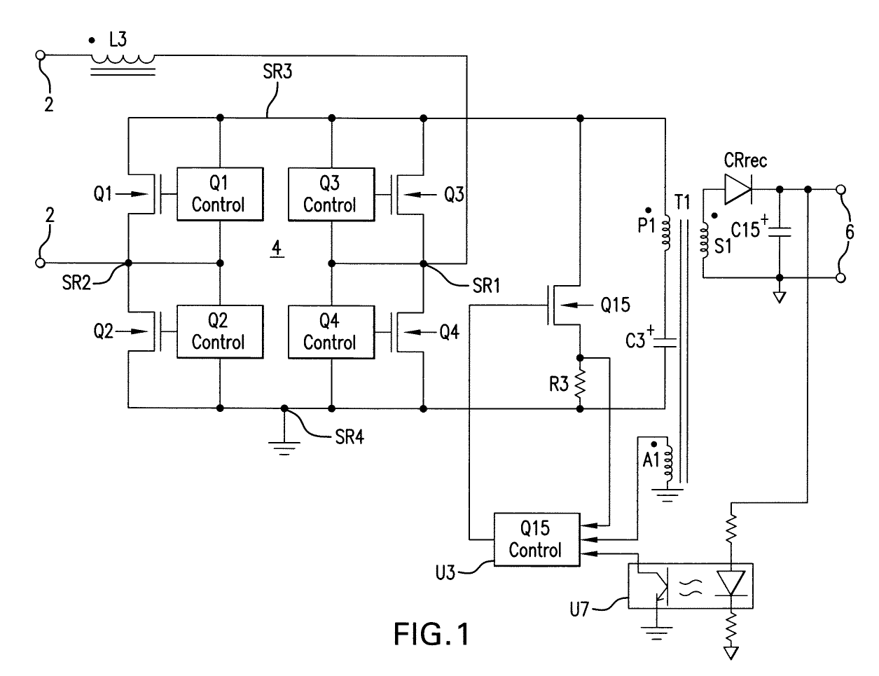

Referring to FIG. 1, there is shown a combination block diagram/schematic diagram which illustrates a configuration of the invention. A pair of input terminals 2 receives a source of AC power. The applied AC voltage may be 120 VAC at 60 Hz, 240 VAC at 50 Hz or some other values of line voltage and line frequency.

A boost inductor L3 is coupled at one end of its winding to one of the input terminals 2 and at the other end of its winding to an input SR1 of a synchronous rectifier 4. The winding is wound around a magnetic core. The synchronous rectifier 4 is comprised of transistors Q1-Q4 and associated control circuits to provide full wave rectification of the AC input voltage. As explained below, the synchronous rectifier also periodically passes current resulting from the release of energy stored in the magnetic core of the boost inductor L3. The second input SR2 of the synchronous rectifier 4 is coupled to the second of the input terminals 2.

In the illustrated embodiment, the transistors Q1-Q4 are N-channel field effect transistors, but P-channel FETs may be used. The first input SR1 of the synchronous rectifier 4 is defined by a node at the junction of the source terminal of transistor Q3 and the drain terminal of transistor Q4. The second input SR2 of the rectifier is defined by a node at the junction of the source terminal of transistor Q1 and the drain terminal of transistor Q2. The drain terminals of transistors of Q1 and Q3 are coupled together to define a first output SR3 of the rectifier. The source terminals of transistors Q2 and Q4 are coupled together to define a second output SR4 of the rectifier. In the embodiment of FIG. 1, the output SR4 is coupled to ground, i.e., primary side DC ground.

The gates of the transistors Q1-Q4 are controlled by respective control circuits. When a control circuit applies a voltage to the gate of its transistor which exceeds the voltage at the source of the transistor by V_{GS}, the transistor will turn on and allow current to flow through the source/drain path of the transistor. When the transistor is off, it exhibits the property of having a diode, called a body diode or a parasitic diode, coupled between the drain and source. For an N-channel FET, the cathode of the diode is coupled to the drain and the anode of the diode is coupled to the source. A P-channel FET has a similar body diode characteristic, except that the diode is reversed, such that the cathode is coupled to the source and the anode is coupled to the drain.

The control circuits for transistors Q1-Q4 monitor the voltage at the inputs SR1, SR2 of the synchronous rectifier 4 in relation to the voltages at the outputs SR3, SR4 of the rectifier. In other words, a control circuit is coupled in parallel with the drain and source of the transistor which it controls to determine the polarity of the voltage across the transistor and control the on/off state of the transistor accordingly. The control circuits cause transistors Q2, Q3 to turn on, and transistors Q1, Q4 to turn off, during the positive phase of the sinusoidal AC line voltage. Conversely, during the negative phase of the AC line voltage, transistors Q1, Q4 are turned on and transistors Q2, Q3 are turned off.

The output terminals SR3, SR4 of the synchronous rectifier 4 are coupled to a load, which as explained more fully below comprises winding P1 in series with capacitor C3, or transistor Q15 (if it is on) in series with resistor R3. During the positive phase of the AC line voltage, current flows from the input SR1, through the source/drain path of a transistor Q3, through the load, through the source/drain path of on transistor Q2, to the input terminal SR2. Current is blocked from flowing through off transistors Q1, Q4 due to their respective body diode characteristics. That is, transistor Q4 behaves as a diode having its cathode coupled to the input SR1 and its anode coupled to output SR4, and transistor Q1 behaves as a diode having its cathode coupled to terminal SR3 and its anode coupled to terminal SR2. Conversely, during the negative phase of the AC line voltage, current flows from input SR2, through the source/drain path of on transistor Q1, through the load, through the source/drain path of on transistor Q4 to the input terminal SR1. Current is blocked from flowing through off transistors Q2, Q3 due to their respective body diode characteristics.

One of the outputs SR4 of the synchronous rectifier 4 is connected to ground. The other of the rectifier outputs SR3 is coupled to one input of the primary winding P1 of transformer T1. The other end of the primary winding P1 is coupled to a first terminal of capacitor C3. The capacitor C3 is preferably a bulk storage capacitor, in which case the primary winding is coupled to the positive terminal of the capacitor. The other terminal of capacitor C3 is connected to synchronous rectifier output SR4, i.e., primary side ground. The primary winding P1 of transformer T1 is wound around a magnetic core. The transformer windings may be wires, but in the preferred embodiment, they are circuit traces patterned on a circuit board.

A transistor Q15, which acts as a switch, is coupled across the output of the synchronous rectifier 4. For current monitoring purposes, a very small value resistor R3 is coupled in series with the transistor Q15 across the output of the rectifier. That is, for the N-channel transistor Q15, the drain of the transistor is coupled to the node defined by the junction of the rectifier output SR3 and the primary winding P1 of transformer T1, and the source of transistor Q15 is coupled to a first end of the resistor R3, the second end of which is coupled to ground.

A control circuit U3 provides a signal to the gate of transistor Q15 to control the transistor to be on or off. The control circuit U3 illustratively has three inputs. The first is the voltage across the small value resistor R3. This voltage is proportional to the current flowing through the transistor Q15 when the transistor is on, i.e., the switch is closed. A second input to the control circuit U3 is provided by an auxiliary winding A1 which is wound around the same magnetic core of the transformer T1 as primary winding P1. As noted by the dots adjacent windings P1 and A1, these windings are in the same phase relationship around the core of transformer T1. The third input to the control circuit U3 is a feedback control signal, the magnitude of which is determined by the output voltage delivered to the load which the converter circuit is powering. As illustrated in FIG. 1, the feedback signal is provided by the output of an optocoupler U7, the input of which is coupled to the converter output. Use of the optocoupler provides isolation between the primary and secondary sides of the converter.

The secondary side of the converter includes a secondary winding S1 which is wound around the same magnetic core as the primary winding P1 is wound. The dots adjacent windings P1 and S1 show that the windings are in the same phase relationship. One end of the secondary winding is coupled to secondary side ground. The other end of the secondary winding S1 is coupled to the anode of rectifier diode CRrec. The cathode of diode CRrec is coupled to a first terminal of capacitor C15, the other terminal of which is connected to secondary side ground. The output terminals 6 of the power converter provide a regulated DC output voltage.

In operation, the control circuit U3 controls the transistor Q15 to turn on and off at a frequency which is many times faster than the line frequency of the AC input voltage. For example, the switching frequency of the transistor may be in the range of 50-120 KHz, while the AC line frequency may be in the range of 50-60 Hz. In the preferred embodiment as explained below, the switching frequency varies as a function of load, and for a constant load, as a function of the phase of the AC input voltage.

When AC power is first applied to the input terminals 2, the control circuit U3 controls the transistor Q15 to be off. Current will flow through the synchronous rectifier 4 and through winding P1 so that capacitor C3 is charged to the peak of the line voltage, illustratively on the order of 170 VDC for a 120 V RMS AC input voltage, or 340 V DC for a 240 V RMS AC input voltage. During this time, no net energy is stored in the core of boost inductor L3 since any temporarily stored energy is provided to the capacitor C3 as charging current.

Subsequently, the control circuit U3 causes the transistor Q15 to turn on. As a result, a very low resistance path (nearly a short circuit, but for the presence of the low value resistor R3) is provided across the output of the synchronous rectifier 4. This causes energy to be stored in the magnetic core of the inductor L3. In this circuit, the current path is L3, Q3, drain to source of Q15, R3, Q2; or Q1, drain to source of Q15, R3, Q4, and L3. At the same time, current from the positive terminal of the charged capacitor C3 flows through the primary winding P1 of transformer T1, then from the drain to source of the transistor Q15, through R3 to the negative terminal of the capacitor C3. The flow of current through the primary winding P1 of the transformer T1 causes energy to be stored in the magnetic core of the transformer T1.

Thus, closure of the transistor Q15 switch creates two parallel circuits which have current flowing in the same direction (drain to source) through the transistor Q15. In the first circuit, the AC line acts as a source to load the magnetic core of the inductor L3 with energy. In the second circuit, the capacitor C3 acts as a DC voltage source to load the magnetic core of the transformer T1 with energy.

During the time the transistor Q15 switch is closed, the control circuit U3 compares the voltage across R3 (which depends on the current through transistor Q15) to the feedback signal from the optocoupler U7. Based on this comparison, the control circuit U3 determines when sufficient energy has been delivered to the magnetic cores of inductor L3 and transformer T1 for the converter (upon delivery of such energy to the secondary) to maintain the desired voltage and current output levels for the present load. Once the condition is met, the control circuit U3 causes the transistor Q15 to turn off, i.e., the switch to open.

When the transistor Q15 switch opens, the voltage on the primary winding P1 wants to rapidly increase (“flyup”). However, the primary voltage is clamped to some value dependent on the voltage across the secondary winding (which is substantially equal to the DC output voltage) and the turns ratio of the transformer T1. For example, if the output voltage (the voltage across capacitor C15) is 20V and the turns ratio of the transformer T1 is 4:1, the voltage across the primary P1 is clamped to approximately 80V. With the transistor Q15 off, there is no return path for the primary winding. The synchronous rectifier 4 does not provide a return path for the primary winding because transistors Q1 and Q4 (or transistors Q2 and Q3) are off with their body diodes acting as blocking diodes. With no return path for the primary winding, the energy stored in the core of transformer T1 is “dumped” by the transformer into the secondary winding S1 as current, which flows into capacitor C15 and to the output load.

When transistor Q15 turns off, the energy stored in the boost inductor L3 results in the flow of current from the inductor L3 through transistor Q3, the primary winding P1, to the capacitor C3 and transistor Q2 (or through transistor Q1, the primary winding P1, the capacitor C3, through transistor Q4, from inductor L3). The current to capacitor C3 (re-) charges the capacitor. The current flowing through the primary winding P1 is delivered, via transformer T1, to the secondary winding S1 to charge capacitor C15 and provide current to the output load. Assuming again a 4:1 turns ratio for the transformer T1, the amount of current delivered to capacitor C15 by the secondary winding S1 is approximately four times the amount of the primary current. The amount of current relatively delivered to capacitors C3 and C15 is a function of their relative capacitance values, as well as the turns ratio of transformer T1.

In addition to the secondary winding S1, the transformer T1 includes the auxiliary winding A1 through which (a relatively small amount of) current is induced to flow by the energy dumped from the core of transformer T1 and by the current flowing the primary winding P1. As indicated by the dots adjacent the primary winding P1 and the auxiliary winding A1 in FIG. 1, the windings are wound around the core of transformer T1 in the same phase relationship. Via the auxiliary winding A1, the control circuit U3 monitors the voltage across the auxiliary winding A1 to determine when the secondary current reaches zero (alternatively, to determine when the secondary current reverses direction). At such point, the cores of the boost inductor L3 and the transformer T1 have delivered all of their energy. In the preferred embodiment, such point in time (or a small delay thereafter) is when the control circuit U3 turns transistor Q15 back on to repeat the loading of the boost inductor L3 magnetic core by the AC power source and of the transformer T1 magnetic core by the bulk storage capacitor C3.

Once the primary current has decayed to zero, with the transistor Q15 off, the capacitance of the transistor in combination with the primary winding inductance and capacitance form a resonant circuit. Depending on values for the capacitance and inductance, such circuit has a resonant frequency of a few megahertz. Turning on the transistor Q15 just as (or slightly after) the circuit commences to resonant operates the flyback converter in the so-called quasi-resonant mode. Thus, the quasi-resonant mode of operation is preferably used.

When the circuit of FIG. 1 is operated in the quasi-resonant mode, the transistor Q15 will turn on at the point in time at which all of the energy from the cores of inductor L3 and transformer T1 has been delivered to the secondary. The duration for which transistor Q15 is on varies as a function of load and as a function of the phase of the AC input voltage. Concerning frequency variations as a function of load, it will be assumed that the switching frequency of the transistor Q15 is observed when the AC input voltage is at the same phase (e.g., at its positive peak) for two different load conditions. With this assumption, the switching frequency will decrease with an increasing load, and will increase for a decreasing load. This is because transistor Q15 has to stay on longer for the cores of inductor L3 and transformer T1 to accumulate the additional energy needed for an increased load and has to stay off longer to provide such additional energy to the load.

For a constant load condition, the switching frequency of the transistor Q15 is lower when the AC input voltage is at or near the zero axis as compared to when the AC input voltage waveform is at or near its peak. When the AC input voltage is at or near its peak, the boost inductor is able to accumulate in its core substantial energy in a relatively short time. Similarly, when the AC input voltage is at or near its peak, the transformer T1 core is able to store in its core the remainder of the needed energy from C3 in a relatively short time. On the other hand, when the AC input voltage is at or near the zero axis, the boost inductor can accumulate in its core only a relatively small amount of energy within a given time. Accordingly, most of the energy to be delivered to the secondary must be accumulated in the transformer core from capacitor C3. Because the AC input voltage is small (the waveform is at or near the zero axis), the time needed for sufficient energy to be accumulated within the transformer core is relatively long. For a constant load, the amount of time required to deliver the accumulated energy to the secondary winding Si is the same in both cases. But because the energy accumulation period is longer when the AC voltage is near the zero axis, the switching frequency is lower than when the AC voltage is near its peak. Illustratively, the switching frequency is approximately twice as high when the AC input voltage is at or near its peak as compared to when the AC input voltage is at or near the zero axis.

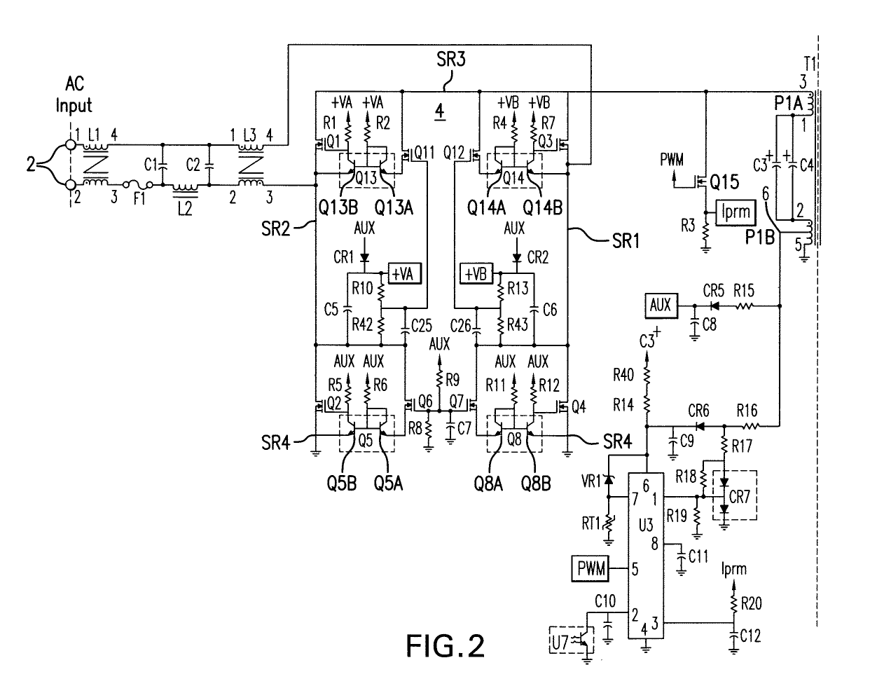

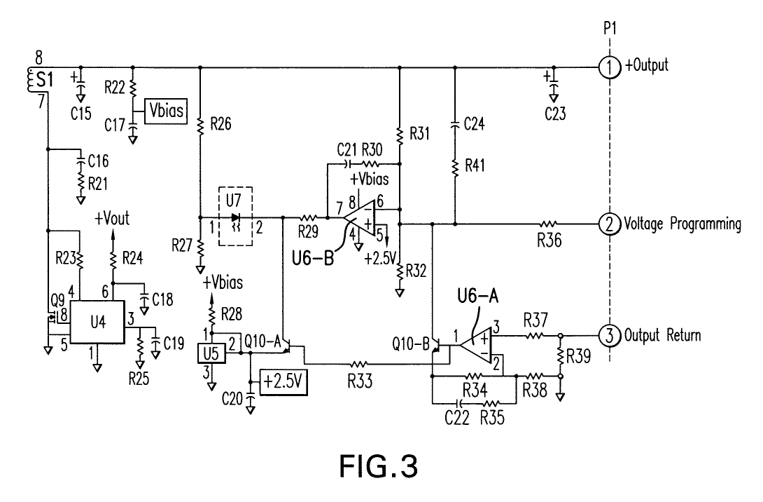

FIGS. 2 and 3 together constitute a schematic diagram of a circuit according to an embodiment of the invention. The figures are divided at the isolation boundary represented by the dashed line extending vertically on the right side of FIG. 2. That is, FIG. 2 illustrates the circuitry on the primary side, and FIG. 3 illustrates the circuitry on the secondary side.

Referring to FIG. 2, AC power is received at the input terminals 2. The input terminals 2 are coupled to an inductor L1 which serves as a common mode electromagnetic interference (EMI) filter. One of the outputs of the EMI filter is coupled to a fuse F1. Following the fuse is a filter, comprised of capacitors C1, C2 and inductor L2. This filter suppresses differential mode electromagnetic interference produced by the converter.

The circuit of FIG. 2 utilizes a balanced architecture in the sense that the primary of the transformer T1 consists of two windings P1A, P1B with bulk storage capacitors C3, C4 coupled in parallel with each other and in series between the two primary windings. This architecture is beneficial in the suppression of common mode noise applied to the input of converter. Primary winding P1B includes a tap at pin 6 to function as an auxiliary winding like winding A1 in FIG. 1. Pin 6 of primary winding P1B is coupled to resistor R15, diode CR5 and capacitor C8 to provide an auxiliary voltage AUX, which is illustratively on the order of 15 VDC. The pin 6 tap of primary winding P1B is used to provide additional voltage and current sources, as explained below in conjunction with pulse width modulation control.

Following the differential mode EMI filter is the boost inductor L3. Owing to the balanced architecture, the boost inductor has two windings wound around a common magnetic core. As shown by the dots adjacent the illustrated windings, the windings are wound in opposite phase relationship around the common magnetic core. One of the windings of boost inductor L3 is coupled at one end to a first of the AC input lines, via the EMI filters, and at the other end to the first input SR1 of the synchronous rectifier 4. The second of the windings of the boost inductor L3 is coupled at one end to the second of the AC input lines, via the EMI filters and the fuse, and at the other end to the second input SR2 of the synchronous rectifier 4: As in FIG. 1, the synchronous rectifier 4 is comprised of transistors Q1-Q4 and their associated control circuits. The node at the junction of the drains of transistors Q1 and Q3 provides the positive output SR3 of the synchronous rectifier 4. The negative output SR4 of the synchronous rectifier, i.e., the junction of the sources of transistors Q2 and Q4, is coupled to primary side ground.

The control circuit for transistor Q4 includes the NPN transistor pair Q8, the N-channel FET Q7, resistors R11, R12, R8 and R9 (the latter two resistors also being shared with the control circuit for transistor Q2). The drain of transistor Q7 is coupled to synchronous rectifier input SR1. The gate of transistor Q7 receives a voltage of approximately 5V via the R8, R9 voltage divider coupled to voltage AUX. The source of transistor Q7 is coupled to the emitter of the first transistor Q8A of the transistor pair Q8. The base and collector of the transistor Q8A are coupled together and to the base of the transistor Q8B to form a node which is coupled to the voltage AUX via resistor R11. The emitter of transistor Q8B is coupled to synchronous rectifier output SR4, i.e., primary side ground, to which the source of synchronous rectifier transistor Q4 is also coupled.

During the positive cycle of the AC input voltage, the voltage on synchronous rectifier input SR1 is some positive value relative to primary side DC ground. Such voltage is applied to the drain of transistor Q7 which acts to limit the magnitude of the voltage. The limited voltage is provided to the emitter of transistor Q8A, which serves as the input of the amplifier formed by the transistor pair Q8. During the positive AC cycle, the voltage at the emitter of Q8A will be sufficiently high so that transistor Q8A is off and not drawing (via its collector) current from voltage AUX via resistor R11. Current from voltage AUX via resistor R11 is therefore supplied to transistor Q8B, which as a result is on. With transistor Q8B on, its collector output is low, which in turn causes transistor Q4 to be off. The body diode characteristic of off transistor Q4 blocks current from passing through transistor Q4.

During the negative cycle of the AC input voltage, the voltage on synchronous rectifier input SR1 is some negative value relative to primary side DC ground. Such negative voltage (as limited by transistor Q7) is applied to the emitter of transistor Q8A to turn on transistor Q8A. With transistor Q8A on, it draws enough current, via its collector, from voltage AUX via resistor R11 so that insufficient current is provided to transistor Q8B to maintain it on. With transistor Q8B off, its collector output is high, which in turn causes transistor Q4 to be on (to pass current via its source/drain path to terminal SR1 after the current has travelled through transistor Q1 (see below), winding P1A, capacitors C3, C4 and winding P1B).

The control circuit for transistor Q2 is configured the same as the control circuit for transistor Q4, except that transistor Q6 is the limiting transistor, having its drain coupled to synchronous rectifier input SR2. The source of transistor Q6 is coupled to the emitter of transistor Q5A. Transistors Q5A, Q5B in transistor pair Q5 are configured as transistors Q8A, Q8B in transistor pair Q8. Since transistor Q6 is coupled to synchronous rectifier input SR2, transistor Q6 and transistor pair Q5 control transistor Q2 to be on during the positive cycle of the AC input voltage and to be off during the negative cycle of the AC input voltage.

Transistor Q11 and transistor pair Q13 act to control transistor Q1 in the same manner, including AC phase, as transistor Q7 and transistor pair Q8 act to control transistor Q4. However, since the emitter of transistor Q13B is coupled to synchronous rectifier input SR2, and the drain of transistor Q11 is coupled to synchronous rectifier output SR3, it is necessary to provide a higher supply voltage to transistor pair Q13 and a higher drive voltage to the gate of transistor Q11. A floating bias circuit, which includes capacitors C5, C25 (which are referenced to terminal SR2), resistors R10, R42 and diode CR1, is used to provide supply voltage+VA to the transistor pair Q13 and the voltage to drive the gate of transistor Q11.

Transistor Q12 and transistor pair Q14 act to control transistor Q3 in the same manner, including AC phase, as transistor Q6 and transistor pair Q5 act to control transistor Q2. The emitter of transistor of Q14B is coupled to synchronous rectifier input SR1 and the drain of transistor Q12 is coupled to synchronous rectifier output SR3. The higher supply voltage+VB for transistors Q14A, Q14B and the higher drive voltage for the gate of transistor Q12 is provided by floating bias circuitry which includes capacitors C6, C26 (which are referenced to terminal SR1), resistors R13, R43 and diode CR2.

The transistors Q1-Q4 are thus synchronously controlled by the AC input voltage so that during the positive phase of the cycle, transistors Q1, Q4 are off, blocking current flow due to their body diode characteristics, and transistors Q2, Q3 are on allowing current to pass through their respective source/drain paths with little conduction loss. Conversely, during the negative phase of the AC cycle, transistors Q2, Q3 are off and transistors Q1, Q4 are on. The control circuits are biased such that when the AC input voltage is approximately 3.5 V when the current direction is about to reverse, a transistor which is on is controlled to turn off linearly (as the AC input voltage continues to decrease) so that the charge across the transistor trickles down slowly before the transistor is turned off completely to block current flow by use of its body diode characteristic.

The Node SR3 serves as the positive output of the synchronous rectifier, which is coupled to one end of primary winding P1A of transformer T1. The other end of winding P1A is coupled to the positive input terminals of the parallel-coupled bulk storage capacitors C3, C4. The other terminals of the capacitors C3, C4 are coupled to one end of primary winding P1B of transformer T1. The other end of winding P1B is connected to rectifieri output SR4, i.e., primary side ground.

The drain of the switching transistor Q15 is connected to the positive output SR3 of the synchronous rectifier 4 and the first end of primary winding P1A. The source of transistor Q15 is coupled to one end of the resistor R3, the other end of which is connected to rectifier output SR4, i.e., primary side ground. The gate of transistor Q15 is coupled to pin 5 (PWM) of the control circuit U3.

The control circuit U3 is illustratively an ON Semiconductor® NCP1380 Quasi-Resonant Current Mode Controller. When AC power is initially applied to the converter, the control circuit U3 derives its power from the voltage across capacitor C9 which is charged by current flowing from the positive terminal C3+ of the bulk storage capacitor C3, via resistors R40, R14. Once the converter has been supplied with a few cycles of the AC input voltage, the capacitor C9 is charged by current from the auxiliary winding at pin 6 of the primary winding P1B of the transformer T1, and the circuit U3 takes its supply voltage therefrom.

The pin 6 P1B auxiliary winding is coupled via resistors R16, R17, R18, R19 and diode pair CR7 to the detect pin 1 of the control circuit U3. The control IC uses this input to determine when the flow of current through the primary winding (with the transistor Q15 off) has decayed to zero (or reversed direction) so that the control IC will, via the PWM signal, turn the transistor Q15 on to load the magnetic cores of boost inductor L3 and transformer T1. As previously noted, the control circuit U3 preferably controls the converter to operate in the quasi-resonant mode.

The transistor Q15 is turned on by the control circuit U3 for the period of time needed for the magnetic cores of the boost inductor L3 and transformer T1 to be loaded with energy sufficient to maintain the desired output voltage and output current based on the present load. To make such determination, the control IC senses at pin 3 (via the voltage, Iₚᵣₘ, across the resistor R3) the current flow through the transistor Q15 and compares it to the feedback signal (received at pin 2) provided by the phototransistor of the optocoupler U7.

Referring to FIG. 3, the light emitting diode portion of the photocoupler U7 is coupled to voltage+Output (connector P1 pin1) and a voltage programming control input (connector P1 pin 2) to provide to the phototransistor of U7 an optical signal indicative of the difference between the actual magnitude of Vout (+Output) and the desired magnitude of Vout. The phototransistor of U7 converts the optical signal to the feedback signal provided to the control circuit U3 on the primary side of the isolation boundary. The photocoupler U2 is, for example, a NEC® PS2561 photocoupler.

Still referring to FIG. 3, the primary winding S1 has one of its ends connected to the positive terminals of capacitors C15 and C23 to provide voltage+Output (Vout). Rectification of the secondary current is synchronously provided by transistor Q9. The drain of transistor Q9 is coupled to the secondary winding and its source is connected to secondary side ground. The gate of transistor Q9 is driven by the output of U4, which is illustratively a Monolithic Power Systems MP6902 synchronous rectifier driver IC.

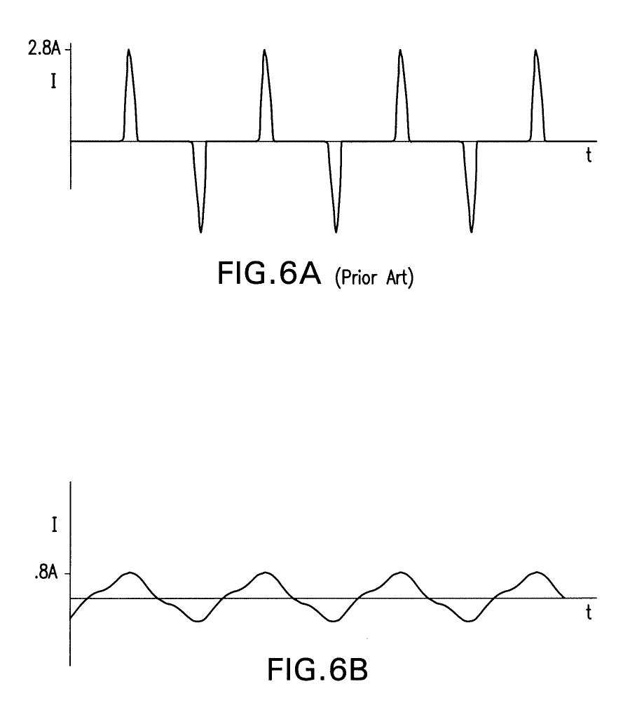

The circuit of FIGS. 2 and 3 operates as described above for the circuit of FIG. 1. The prior art power supply which produced the input current waveform of FIG. 6A was replaced by the circuit of FIG. 2 using the same load and input voltage. The waveform of the input current drawn by the FIG. 2 circuit is shown in FIG. 6B. As can be seen, the FIG. 2 circuit lowers the peak current drawn by a factor of approximately 3.5 compared to the prior art power supply. Additionally, the FIG. 2 circuit substantially expands the current waveform to result in a waveform which is much more sinusoidal. The FIG. 2 circuit was measured to have a power factor of 0.95, with harmonic content below the limits specific by European Union regulation EN61000-3-2.

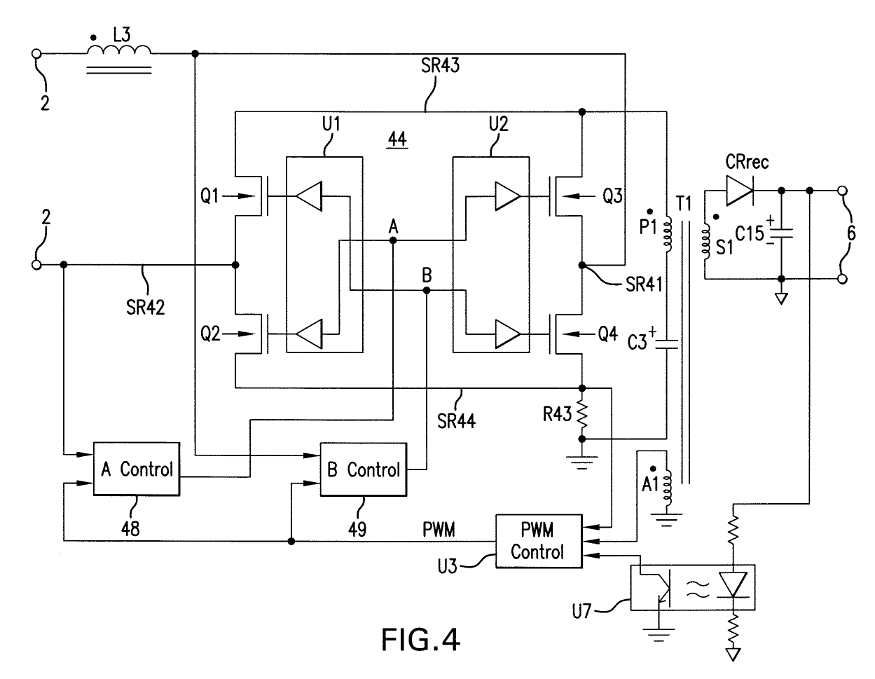

FIG. 4 is a combination block diagram/schematic diagram of an alternative embodiment of the invention. In this embodiment, the function of the switching transistor Q15 in FIGS. 1 and 2 is performed by the synchronous rectifier transistors Q1-Q4 which are configured in the same arrangement as in FIGS. 1 and 2, but controlled differently as explained below. As in the prior embodiment, a boost inductor L3 is coupled to one of the AC input terminals 2. The other terminal of the boost inductor L3 is coupled to the synchronous rectifier 44 input terminal SR41. The other terminal of the AC input terminals 2 is coupled to synchronous rectifier input terminal SR42. A first rectifier output terminal SR43 is coupled to a first terminal of the primary winding P1 of transformer T1. The second terminal of winding P1 is coupled to the positive terminal of bulk storage capacitor C3, the negative terminal of which is coupled to primary side ground. The synchronous rectifier output terminal SR44, defined by the junction of the source terminals of transistors Q2 and Q4, is coupled to a first end of a small value resistor R43, the other end of which is coupled to primary side ground.

The gates of transistors Q1, Q2 are controlled by respective output signals of a driver U1. The gates of transistors Q3, Q4 are controlled by respective output signals of a driver U2. The drivers U1, U2 each receive a pair of control signals A, B as inputs. The drivers U1, U2 are connected such that the control signal A simultaneously controls the on/off state of transistors Q2, Q3, and the control signal B simultaneously controls the on/off state of transistors Q1, Q4.

The control signal A is provided to the drivers U1, U2 by an A Control block 48, and the control signal B is provided to the drivers by a B Control block 49. The A Control block 48 receives as an input the voltage at the input terminal SR42 of the synchronous rectifier 44. The B Control block 49 receives as an input the voltage at the input terminal SR41 of the rectifier. In addition, each of the control blocks 48, 49 receives as an input a PWM control signal output by the PWM Control block U3.

As in the prior embodiment, the control block U3 receives three input signals. The first is the voltage across the small value resistor R43. A second input to the control block U3 is provided by the auxiliary winding A1 which is wound around the same magnetic core of the transformer T1 as primary winding P1. The third input to the control block U3 is the feedback control signal, provided by the opto-coupler U7, having a magnitude which is determined by the converter output voltage.

During the positive phase of the AC input voltage, the A Control block outputs a high level A signal and the B Control block outputs a low level B signal. As a result, the drivers U1, U2 turn on transistors Q2, Q3 and turn off transistors Q1, Q4. The body diodes of off transistors Q1, Q4 block the flow of current. Thus, during the positive AC cycle, current will flow from rectifier input SR41, through transistor Q3, through primary winding P1, to the capacitor C3, through resistor R43, through transistor Q2 to rectifier input SR42. During the negative phase of the AC input voltage, the A Control block outputs a low level A signal and the B Control block outputs a high level B signal. As a result, the drivers U1, U2 turn on transistors Q1, Q4 and turn off transistors Q1, Q3. The body diodes of off transistors Q2, Q3 block the flow of current. Thus, during the negative AC cycle, current will flow from rectifier input SR42, through transistor Q1, through primary winding P1, to the capacitor C3, through resistor R43, through transistor Q4 to rectifier input SR41.

When AC power is first applied to the input terminals 2, the PWM control circuit U3 outputs a low level PWM signal which does not affect the A and B control signals output by the A Control and B Control blocks. Thus, transistors Q1-Q4 provide synchronous rectification of the AC power to charge capacitor C3 to the peak of the AC line voltage. During this time, no net energy is stored in the core of the boost inductor L3 since any temporarily stored energy is provided to the capacitor C3 as charging current.

Once the capacitor C3 has been fully charged, the PWM Control U3 will output a high level PWM control signal. The PWM control signal is provided to each of the A Control block 48 and the B Control block 48. Within each of the A Control and B Control blocks 48, 49, the PWM control signal is connected in a wired OR arrangement with the output of the circuitry within the respective blocks which monitors the input voltage to output the respective A and B control signals. Thus, if the PWM signal is a low level, it does not impact either the A or B control signals, and each signal is a high level or a low level in accordance with the voltage at nodes SR41, SR42, as explained above. On the other hand, when the PWM signal is a high level, each of the A and B control signals will be at a high level regardless of the phase of the AC input voltage, i.e., for both the positive and negative phases of the AC input voltage. In such case, the drivers U1, U2 will cause each of the transistors Q1-Q4 to be on.

With each of transistors Q1-Q4 in the on state, a near short circuit is created across terminals SR41 and SR42 (transistors Q4 and Q2 are both on). This causes energy from the AC line to be stored in the magnetic core of the boost inductor L3. At the same time, current from the positive terminal of the charged capacitor C3 flows through the primary winding P1, to terminal SR43, to terminal SR44 (via two parallel paths, on transistors Q1, Q2 and on transistors Q3, Q4), through resistor R43, to the negative terminal of capacitor C3. The flow of current through the primary winding P1 causes energy to be stored in the magnetic core of the transformer T1. Thus, the high level PWM signal causes the magnetic core of the boost inductor L3 to be loaded with energy from the AC line and causes the magnetic core of the transformer T1 to be loaded with energy from the capacitor C3.

During the time that current is flowing through resistor R43, the PWM Control block U3 compares the voltage across R43 to the feedback signal from the opto-coupler U7. When a satisfactory voltage across R43 has been established, the PWM Control block U3 causes the PWM signal to return to a low level.

With the PWM signal now low, it no longer overrides the A Control and B Control blocks 49, 49 to cause both the A and B control signals to be at a high level. Thus, the state of the A and B control signals is respectively determined by the usual operation of the A Control and B Control blocks based on the voltage at the terminals SR42 and SR41, respectively.

Just prior to the PWM signal going low, for the positive phase of the AC cycle, current from the boost inductor is flowing from the drain to the source of transistor Q4 and from the source to the drain of transistor Q2. Thus, the voltage at the drain of transistor Q4 is slightly higher than the voltage at its source, and the voltage at the source of transistor Q2 is slightly higher than the voltage at its drain. The voltage at the drain of transistor Q4 is still being monitored by the B control block 49 and the voltage at the drain of transistor Q2 is still being monitored by the A control block 48. The higher voltage (relative to primary side ground) at the drain of transistor Q4 (node SR41) cause the B Control block 49 to output a low level B control signal once the PWM signal goes low. On the other hand, the lower voltage (relative to primary side ground) at the drain of transistor Q2 causes the A Control block 48 to output a high level A control signal even after the PWM signal goes low.

Thus, due to the current flow from the boost inductor L3, the A control signal stays high and the B control signal goes low after the PWM signal goes low. In response to such states of the A and B control signals, the drivers U1, U2 cause transistors Q3, Q2 to stay on and transistors Q4, Q1 to turn off. Accordingly, after the PWM signal goes low, the current from the boost inductor L3 flows from the source to the drain of transistor Q3, through the primary winding P1 to the capacitor C3, through resistor R43, and from the source to drain of transistor Q2. The current to capacitor C3 (re-) charges the capacitor. The current flowing through the primary winding P1 is delivered, via the transformer T1, to the secondary winding S1 to charge the capacitor C15 and provide power to the output load.

Once the boost inductor has exhausted all of its energy, the current will fall to zero. As a result, the voltage at terminal SR42 will transition to a level such that the A Control block 48 outputs a low level A control signal. At such time, both the A and B control signals are at a low level and all four transistors Q1-Q4 are off.

Focusing now on the operation of the transformer T1, and returning to the portion of the converter cycle during which the PWM signal has transitioned from a low level to a high level, both the A and B control signals are high and all four transistors Q1-Q4 are on. On transistors Q1, Q2 and Q3, Q4 and resistor R43 provide the near short circuit to cause the magnetic core of the transformer to be loaded with energy from the capacitor C3. When a satisfactory voltage has been established across R43, the PWM signal goes low and transistor Q1, Q4 turn off. With no return path for the primary winding P1, the energy stored in the core the transformer T1 is dumped by the transformer into the secondary winding as current, which flow into capacitor C15 and to the output load.

Considering again the boost inductor L3 current path, for the negative phase of the AC cycle, when the PWM signal is high, current is flowing from the drain to the source of transistor Q2 and from the source to the drain of transistor Q4. Thus, the voltage at the drain of transistor Q2 is slightly higher than the voltage at its source, and the voltage at the source of transistor Q4 is slightly higher than the voltage at its drain. Accordingly, when the PWM signal goes low, transistors Q1, Q4 stay on (and transistors Q2, Q3 turn off) to provide current flow through the primary winding P1, which is transferred to the secondary winding S1, and through capacitor C3 to recharge the capacitor.

When the sinusoidal AC voltage is at or near the zero axis the amount of time which transistors Q2, Q3 (or Q1, Q4) remain on after the PWM signal goes low is shorter than when the AC voltage is at or near its peak. In any event, either two or four of the transistors Q1-Q4 are off after the PWM signal goes low such that the primary winding has no return path, and the energy stored in the core of transformer T1 is dumped into the secondary winding as current.

Via the auxiliary winding A1, the PWM control block U3 monitors the current flow to determine when the primary current has decayed to zero (or reversed direction). At such point, the core of transformer T1 has delivered all of its energy. At this (quasi-resonant) point, the PWM control block U3 will cause the PWM signal to go high to repeat the loading of the boost inductor L3 by the AC power source and of the transformer T1 magnetic core by the bulk storage capacitor C3.

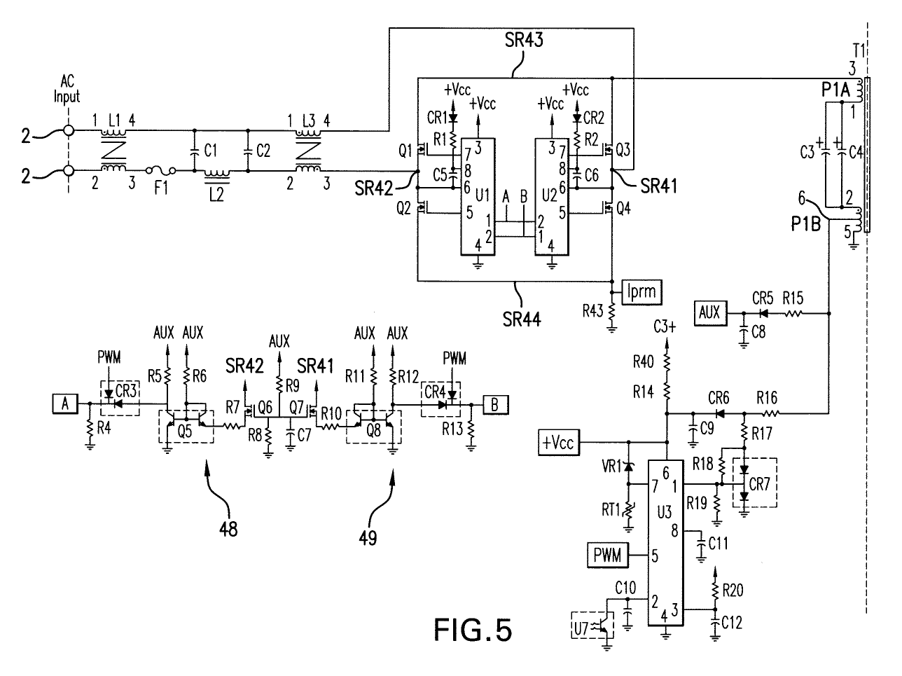

FIG. 5 is a schematic diagram of the primary side of a converter which operates as described above with respect to FIG. 4. The secondary side of the converter is schematically shown in FIG. 3, the description of which is not repeated. Similarly to the FIG. 2 primary side, the FIG. 5 primary side utilizes EMI filters coupled between the AC input terminals 2 and the boost inductor L3. Also similarly to the FIG. 2 primary side, the FIG. 5 primary side utilizes a balanced architecture with the bulk storage capacitor C3 (and the parallel connected bulk storage capacitor C4) being coupled in series between primary winding P1A and P1B.

The A Control circuit 48 and the B Control circuit 49 are configured and operate in the same manner as the Q2 Control and Q4 Control blocks shown in block form in FIG. 1 and schematically in FIG. 2. The diode pair CR3 provides the wired OR of the PWM signal with the output of the transistor pair Q5 to generate the A control signal. Likewise, the diode pair CR4 provides the wired OR of the PWM signal with the output of the transistor pair Q8 to generate the B control signal.

The drivers U1, U2 are illustratively ON Semiconductor® NPC5106 high voltage gate driver ICs. To ensure sufficiently high voltages to drive the gates of transistors Q1, Q3 (which have their source terminals coupled to nodes SR42, SR41, respectively) a booststraping technique is used. The booststrap capacitors C5, C6 are referenced to nodes SR42, SR41 respectively and receive their charging current from voltage+Vcc. The voltage+Vcc is produced by the voltage across capacitor C9 which is charged by the pin 6 tap of winding P1B, corresponding to the auxiliary winding A1 in FIG. 4. The voltage+Vcc is used to provide the low side gate drive voltages to transistors Q2, Q4 and to provide the main power for ICs U1, U2 and U3. As in the FIG. 2 embodiment, U3 in the FIG. 5 embodiment is illustratively an ON Semiconductor® NCP1380 Quasi-Resonant Current Mode Controller IC.

The performance of the FIGS. 5 and 3 circuit is nearly identical to that of the FIGS. 2 and 3 circuit. Accordingly, the input current waveform shown in FIG. 6B is equally applicable to the FIGS. 5 and 3 circuit.

While the description above refers to particular embodiments of the present invention, it will be understood that many modifications may be made without departing from the spirit thereof. The following claims are intended to cover such modifications as would fall within the true scope and spirit of the present invention. The presently disclosed embodiments are therefore to be considered in all respects as illustrative and not restrictive, the scope of the invention being indicated by the claims, rather than the foregoing description, and all changes which come within the meaning and range of equivalency of the claims are therefore intended to be embraced therein.

I claim:

1. A power converter comprising:
a pair of input terminals to receive an AC voltage;
a synchronous rectifier having a pair of inputs and a pair of outputs;
a boost inductor coupled between at least one of the input terminals and one of the synchronous rectifier inputs;
a transformer having a primary winding and a secondary winding, a first terminal of the primary winding being coupled to one of the synchronous rectifier outputs;
a storage capacitor, a first terminal of the storage capacitor being coupled to a second terminal of the primary winding and a second terminal of the storage capacitor being coupled to the other of the synchronous rectifier outputs;
circuitry, including a switch, to provide a low resistance path across the pair of synchronous rectifier outputs when the switch is closed; and
rectification circuitry coupled to the secondary winding to generate a DC output voltage.

2. The power converter of claim 1, wherein the switch is a transistor.

3. The power converter of claim 2 including a control circuit to provide a control signal to the transistor to selectively turn the transistor on and off.

4. The power converter of claim 3, wherein the transformer includes an auxiliary winding, a terminal of the auxiliary winding being coupled as an input to the control circuit.

5. The power converter of claim 4, wherein the control circuit receives as additional inputs a first signal indicative of current flowing through the transistor when the transistor is on and a second signal indicative of a magnitude of the DC output voltage.

6. The power converter of claim 4, wherein the primary winding, the secondary winding and the auxiliary winding are wound around a same magnetic core.

7. A power converter comprising:
first and second input terminals to receive on AC voltage;
a synchronous rectifier having first and second input terminals and first and second output terminals;
a boost inductor having first and second windings wound around a same magnetic core, a first terminal of the first winding being coupled to the first input terminal, a second terminal of the first winding being coupled to the synchronous rectifier first input terminal, a first terminal of the second winding being coupled to the second input terminal, and a second terminal of the second winding being coupled to the synchronous rectifier second input terminal;
a transformer having first and second primary windings and a secondary winding, one terminal of the first primary winding being coupled to the synchronous rectifier first output terminal and one terminal of the second primary winding being coupled to the synchronous rectifier second output terminal;
a storage capacitor coupled between the other of the input terminals of the first and second primary windings;
circuitry, including a switch, to provide a low resistance path across the synchronous rectifier first and second output terminals when the switch is closed; and
rectification circuitry coupled to the secondary winding to generate a DC output voltage.

8. The power converter of claim 7, wherein the first terminal of the boost inductor first winding is coupled to the first input terminal via an EMI filter.

9. The power converter of claim 8, wherein the first terminal of the boost inductor second winding is coupled to the second input terminal via the EMI filter.

10. The power converter of claim 7, wherein the switch is a transistor and the power converter includes a control circuit to provide a control signal to the transistor to selectively turn the transistor on and off.

11. The power converter of claim 10, wherein the transformer includes an auxiliary winding, a terminal of the auxiliary winding being coupled as an input to the control circuit.

12. The power converter of claim 11, wherein the control circuit receives as additional inputs a first signal indicative of current flowing through the transistor when the transistor is on and a second signal indicative of a magnitude of the DC output voltage.

13. A power converter comprising:
a pair of input terminals to receive an AC voltage;
a synchronous rectifier having a pair of inputs and a pair of outputs;
a boost inductor, having a magnetic core, coupled between at least one of the input terminals and one of the synchronous rectifier inputs;
a transformer having a magnetic core, a primary winding and a secondary winding, a first terminal of the primary winding being coupled to one of the synchronous rectifier outputs;
a storage capacitor, a first terminal of the storage capacitor being coupled to a second terminal of the primary winding and a second terminal of the storage capacitor being coupled to the other of the synchronous rectifier outputs;
switching circuitry which when closed causes energy from the AC voltage to be stored in the boost inductor magnetic core and simultaneously causes energy from the storage capacitor to be stored in the transformer magnetic core, and which when open causes the energy stored in the boost inductor magnetic core to be released as current which flows through the primary winding to the storage capacitor and causes the energy stored in the transformer magnetic core to be released; and
rectification circuitry, which receives via the secondary winding induced current resulting from the primary winding current and the transformer core energy release, to generate a DC output voltage.

14. The power converter of claim 13, wherein the switching circuitry is a transistor and the power converter includes a control circuit to selectively turn the transistor on and off.

15. The power converter of claim 14, wherein the control circuit causes the power converter to operate in a quasi-resonant mode.

16. The power converter of claim 15, wherein for a constant load, the control circuit causes the transistor to switch at a frequency which is approximately twice as high when the AC voltage is at or near its maximum as compared to when the AC voltage is at or near its minimum.

17. The power converter of claim 13, wherein the synchronous rectifier and the switching circuitry each includes a same set of four field-effect transistors.

18. The power converter of claim 17, wherein the on/off states of the four field-effect transistors are selectively controlled by control circuitry which monitors voltages respectively present at the synchronous rectifier inputs, and when the switching circuitry is closed, monitors a magnitude of the energy stored in the transformer magnetic core.

19. The power convertor of claim 18, wherein the second terminal of the storage capacitor is coupled to the other of the synchronous rectifier outputs via a resistor and a voltage across the resistor is indicative of the magnitude of the energy stored in the transformer magnetic core when the switching circuitry is closed.

20. The power converter of claim 17, wherein the control circuitry causes the power converter to operate in a quasi-resonant mode.

21. A power converter comprising:
first and second input terminals to receive an AC voltage;
a synchronous rectifier having first and second input terminals and first and second output terminals;
a boost inductor having first and second windings wound around a same magnetic core, a first terminal of the first winding being coupled to the first input terminal, a second terminal of the first winding being coupled to the synchronous rectifier first input terminal, a first terminal of the second winding being coupled to the second input terminal, and a second terminal of the second winding being coupled to the synchronous rectifier second input terminal;
a transformer having first and second primary windings and a secondary winding, one terminal of the first primary winding being coupled to the synchronous rectifier first output terminal and one terminal of the second primary winding being coupled to the synchronous rectifier second output terminal;
a storage capacitor coupled between the other of the input terminals of the first and second primary windings;
switching circuitry which when closed causes energy from the AC voltage to be stored in the boost inductor magnetic core and simultaneously causes energy from the storage capacitor to be stored in the transformer magnetic core, and which when open causes the energy stored in the boost inductor magnetic core to be released as current which flows through the primary windings to the storage capacitor and causes the energy stored in the transformer magnetic core to be released; and
rectification circuitry, which receives via the secondary winding induced current resulting from the primary windings current and the transformer core energy release, to generate a DC output voltage.

22. The power converter of claim 21, wherein the switch is a transistor and the power converter includes a control circuit to selectively turn the transistor on and off.

23. The power converter of claim 22, wherein the control circuit causes the power converter to operate in a quasi-resonant mode.

24. The power converter of claim 23, wherein for a constant load, the control circuit causes the transistor to switch at a frequency which is approximately twice as high when the AC voltage is at or near its maximum as compared to when the AC voltage is at or near its minimum.

25. The power converter of claim 21, wherein the synchronous rectifier and the switching circuitry each includes a same set of four field-effect transistors.

26. The power converter of claim 25, wherein the on/off states of the four field-effect transistors are selectively controlled by control circuitry which monitors voltages respectively present at the synchronous rectifier inputs, and when the switching circuitry is closed, monitors a magnitude of the energy stored in the transformer magnetic core.

27. The power convertor of claim 26, wherein the second terminal of the storage capacitor is coupled to the other of the synchronous rectifier outputs via resistor and a voltage across the resistor is indicative of the magnitude of the energy stored in the transformer magnetic core when the switching circuitry is closed.

28. The power convertor of claim 21, wherein the second terminal of the storage capacitor is coupled to the other of the synchronous rectifier outputs via a resistor and a voltage across the resistor is indicative of the magnitude of the energy stored in the transformer magnetic core when the switching circuitry is closed.
